(19) United States
(12) Patent Application Publication
(10) Pub. No.: US 2005/0074896 A1
(43) Pub. Date: Apr. 7, 2005

(54) Cell for sample detection in chromatography, and method for detecting samples and sample detector using the cell

(75) Inventors: Takao Tsuda, Nisshin-shi (JP); Motonori Munesue, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignees: Takao Tsuda; Motonori Munesue; CHEMCO SCIENTIFIC CO., LTD

(21) Appl. No.: 10/946,480

(22) Filed: Sep. 21, 2004

(30) Foreign Application Priority Data
Oct. 6, 2003 (JP) JP 2003-347397

(51) Int. Cl. G01N 21/00

(52) U.S. Cl. 436/161; 422/71; 436/164

(57) ABSTRACT

A cell for sample detection in chromatography includes a material fixed therein, whose translucency is changed or increased by an interaction with samples. A method for detecting samples in chromatography includes the steps of providing a light-emitting means and a light-receiving means, providing the cell between the light-emitting means and the light-receiving means, making the samples flow through the cell and detecting the components of the samples by utilizing the phenomenon that the translucency of the material fixed in the cell is changed or increased by the interaction with the samples. A sample detector for chromatography includes a light-emitting means, a light-receiving means, and the cell placed between the light-emitting means and the light-receiving means.

### BACKGROUND OF THE INVENTION

This invention relates to a cell for sample detection in liquid chromatography, electrochromatography or the like, and a method for sample detection and a sample detector respectively using the cell.

Conventionally, an absorbance detector and a differential refractometer detector have been used for sample detection in chromatography.

An absorbance detector, which makes use of a phenomenon that samples absorb specific wavelength of light, detects the components of the samples by measuring the amount of light which is absorbed at the specific wavelength of light. (Japanese Patent Application Publication Laid-Open No. 3-226632).

A differential refractometer detector detects the components of the samples by measuring the difference in refractive index between the samples and a solvent both flowing through the detecting cell (Japanese Patent Application Publication Laid-Open No. 2-10248).

However, because the above conventional detectors make use of the particular properties that the samples possess by themselves, they have some problems. Specifically, it is difficult or impossible to detect the components of the samples by the absorbance detector when the samples have low or no absorbance of ultraviolet light or visible light. Also, it is difficult or impossible to detect the components of the samples by the differential refractometer detector when there is few or no difference in the refractive indexes between the samples and the solvent.

Therefore, an object of the present invention is to solve the above problems and to provide a cell for sample detection in chromatography with high sensitivity and high precision which makes it possible to detect the components of the samples having low or no ultraviolet light or visible light absorbance and a method for sample detection and a sample detector respectively using the cell.

### BRIEF SUMMARY OF THE INVENTION

According to the present invention, a cell for sample detection in chromatography includes a material fixed therein, whose translucency is changed or increased by an interaction between the material and samples.

According to the present invention, a method for detecting samples in chromatography includes the steps of providing a light-emitting means and a light-receiving means, providing the above cell between the light-emitting means and the light-receiving means, making the samples flow through the cell and detecting the components of the samples by utilizing the phenomenon that the translucency of the material fixed in the cell is changed or increased by the interaction with the samples.

According to the present invention, a sample detector for chromatography includes a light-emitting means, a light-receiving means, and the above cell placed between the light-emitting means and the light-receiving means.

Therefore, according to the present invention, it becomes possible to detect the components of the samples in a ultraviolet light absorption range by a visible light absorbance detector or to detect the components of the samples in a visible light absorption range by a ultraviolet light absorbance detector by shifting or broadening a light absorption band of the samples from the ultraviolet light absorption range to the visible light absorption range, newly increasing the translucency of the samples within the ultraviolet and/or visible light absorption range, or shifting the translucency from the visible light absorption range to the ultraviolet light absorption range. Therefore, each of the detectors can be used for the samples in either range of ultraviolet or visible light absorption.

In addition, according to the present invention, even when the samples have originally low or no light absorbance, their translucency can be increased by new light absorption caused by the interaction between the fixed material and the samples.

In the present invention, a UV-LED, a Vis-LED, an IR-LED or the like may be used as the light-emitting means while a photodiode, a phototransistor, a photo-IC or the like may be used as the light-receiving means.

In the present invention, any material, any length and any internal diameter can be selected for the cell; for example, a fused silica tube, a quartz glass tube, an optical transparent polymer tube or the like may be selected. However, it is desirable to use a tube with the length of 0.1-3.0 mm and the internal diameter of 10-300 μm as the cell from a standpoint of accuracy and manufacturing. The fused silica tube, when being used as the cell for sample detection, shows a mechanical strength and a structural stability.

In the present invention, a silica gel, an optical transparent polymer or the like may be used as the material whose translucency is changed or increased by an interaction with samples. The silica gel, the optical transparent polymer or the like may be chemically modified with an amino group, an alkyl group, an ion-exchange group or the like.

In the present invention, in order to fix the material, whose translucency is changed or increased by an interaction with samples, in the cell sparsely, a solution in which the material (m) is dissolved may be applied to the inner surface of the cell, a water glass or soluble glass containing the material may be fire-hardened on the inner surface of the cell, or the material may be filled into the cell partitioned by polypropylene frit, polyethylene frit or the like. However, the way of fixing the material to the cell is not limited to them.

In the present invention, all sort of developing reagents, reaction reagents, chemical solutions for treatment, chemical solutions as test agent or the like may be used as samples. Specifically, uracil, benzene, acenaphthene, cyclohexanol, maltose, saccharose, lactose, inositol, phenol, polyvinyl alcohol, ethylene glycol, dextran, sodium argininic acid or the like may be used, but not limited to them.

The present invention has the above-described features, so that in liquid chromatography, electrochromatography and the like, the components of the samples having low or no light absorbance of ultraviolet light or visible light can be detected, and the sample detection can be conducted with high sensitivity and high precision.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a block diagram demonstrating a structure of a liquid chromatography system including a sample detector according to the present invention;

FIG. 2 is a diagrammatic illustration of a sample detector according to the present invention;

FIG. 3 is an enlarged sectional view demonstrating an example of a cell for sample detection according to the present invention;

FIG. 4 is an enlarged sectional view demonstrating another example of a cell for sample detection according to the present invention;

FIG. 5 is a chromatogram of the components of samples detected by using a sample detector according to the present invention;

FIG. 6 is a chromatogram of the components of detected by not using a sample detector according to the present invention;

FIG. 7 is a chromatogram of the components of detected by using a sample detector according to the present invention;

FIG. 8 is a chromatogram of the components of detected by not using a sample detector according to the present invention;

FIG. 9 is a chromatogram of the components of detected by using a sample detector according to the present invention;

FIG. 10 is a chromatogram of the components of detected by not using a sample detector according to the present invention;

FIG. 11 is a chromatogram of the components of detected by using a sample detector according to the present invention; and

FIG. 12 is a chromatogram of the components of detected by using a sample detector according to the present invention.

### DETAILED DESCRIPTION OF THE INVENTION

Referring to the Figures, the following description will discuss embodiments of the present invention.

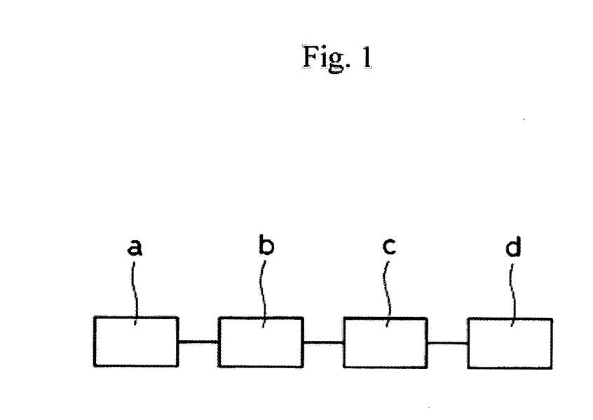

FIG. 1 is a block diagram demonstrating a structure of a chromatography system to be carried according to the present invention. In FIG. 1, (a) indicates a liquid transfer pump, (b) indicates a microinjector for samples, (c) indicates a separation column and (d) indicates a sample detector.

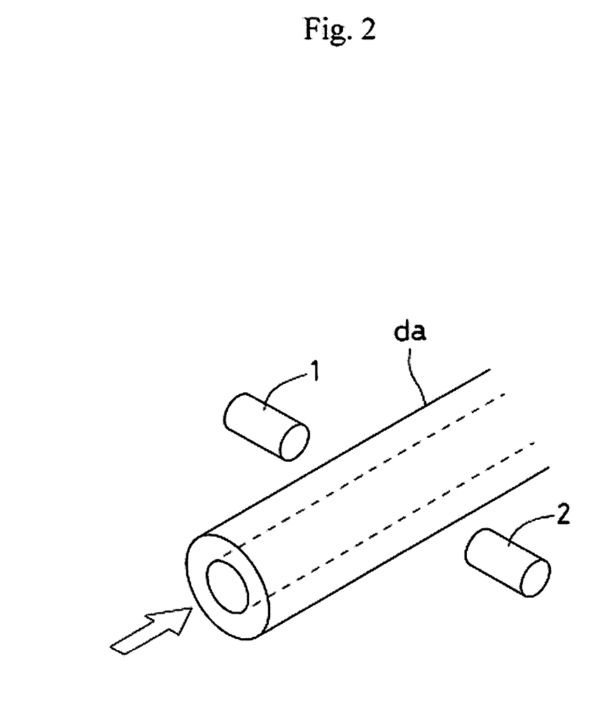

As shown in FIG. 2, the sample detector (d) of the present invention has a light-emitting means (1), a light-receiving means (2) and a cell (da) for sample detection. A material (m), whose translucency is changed or increased by an interaction with samples, is thinly fixed in the cell (da), and the cell (da) is placed between the light-emitting means (1) and the light-receiving means (2). In a method for sample detection using the sample detector (d) of the present invention, the components of the samples are detected by using the feature that the translucency of the material (m) is changed or increased by the interaction between the samples and the fixed material (m) at the time when the samples flow through the cell (da).

A UV-Vis LED is used as the light-emitting means (1), and a photodiode is used as the light-receiving means (2).

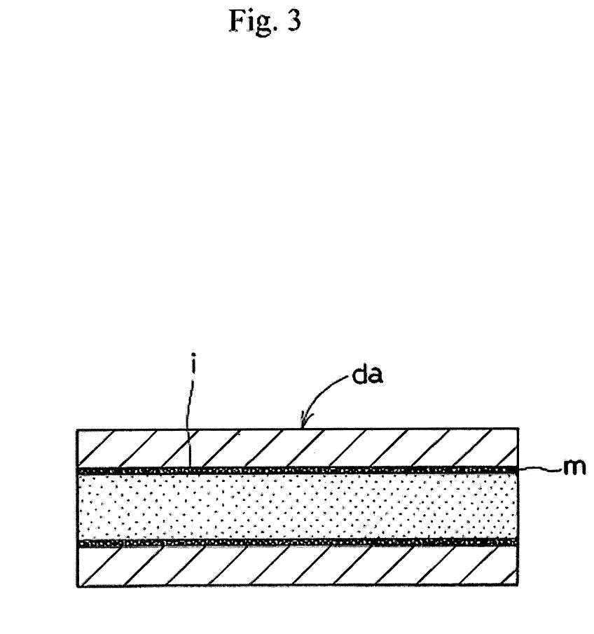

FIG. 3 is an enlarged sectional view demonstrating an example of the cell (da) of the present invention. The material (m) whose translucency is changed or increased by an interaction with samples is applied on the inner surface (i) of the cell (da) and fixed there thinly.

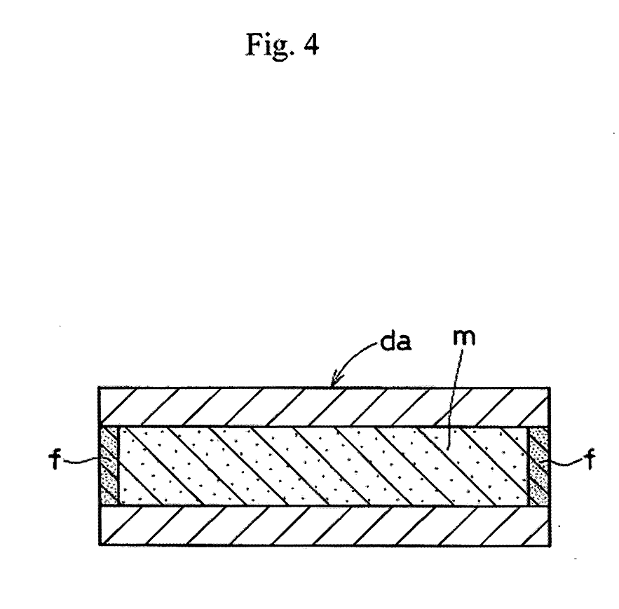

FIG. 4 is an enlarged sectional view demonstrating another example of the cell (da) of the present invention. The material (m) whose translucency is changed or increased by an interaction with samples is filled into a place made by partitioning the cell (da) with frits (f) and fixed there sparsely.

The sample detector having the above-described structure was used to detect the components of samples in chromatography, and the following results were obtained.

### EXAMPLE 1

In the above mentioned chromatography system, the separation column was not used, a 100% methanol was used as a mobile phase, and a mixture solution of uracil, benzene and acenaphthene was used as a sample. The flow rate was set to 2 μl/min. A fused silica tube with the internal diameter of 150 μm in which silica gel with the spherical diameter of 3 μm was fixed sparsely was used as the cell (da). In such a way, sample detection was conducted. For comparison with this cell (da), the same fused silica tube but no silica gel was fixed therein was used to detect the components of the sample under the same condition (Comparative Example 1).

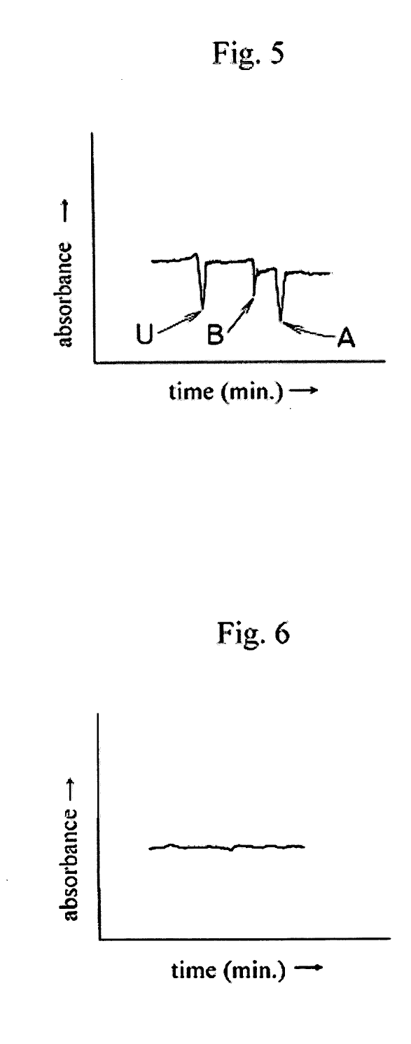

The sample detection was conducted under a visible light range of the wavelength of 400 nm. Consequently, as shown in FIG. 5, a peak (U) for the uracil, a peak (B) for the benzene, and a peak (A) for the acenaphthene were obtained in the Example 1 while as shown in FIG. 6, no peak for the uracil, the benzene or the acenaphthene was obtained in the Comparative Example 1.

### EXAMPLE 2

In the above mentioned chromatography system, the separation column was not used, a 100% methanol was used as a mobile phase, and a cyclohexanol solution was used as a sample. The flow rate was set to 2 μl/min. A fused silica tube with the internal diameter of 150 μm in which silica gel with the spherical diameter of 3 μm was fixed sparsely was used as the cell (da). In such a way, sample detection was conducted. For comparison with this cell (da), the same fused silica tube but no silica gel was fixed therein was used to detect the components of the sample under the same condition (Comparative Example 2).

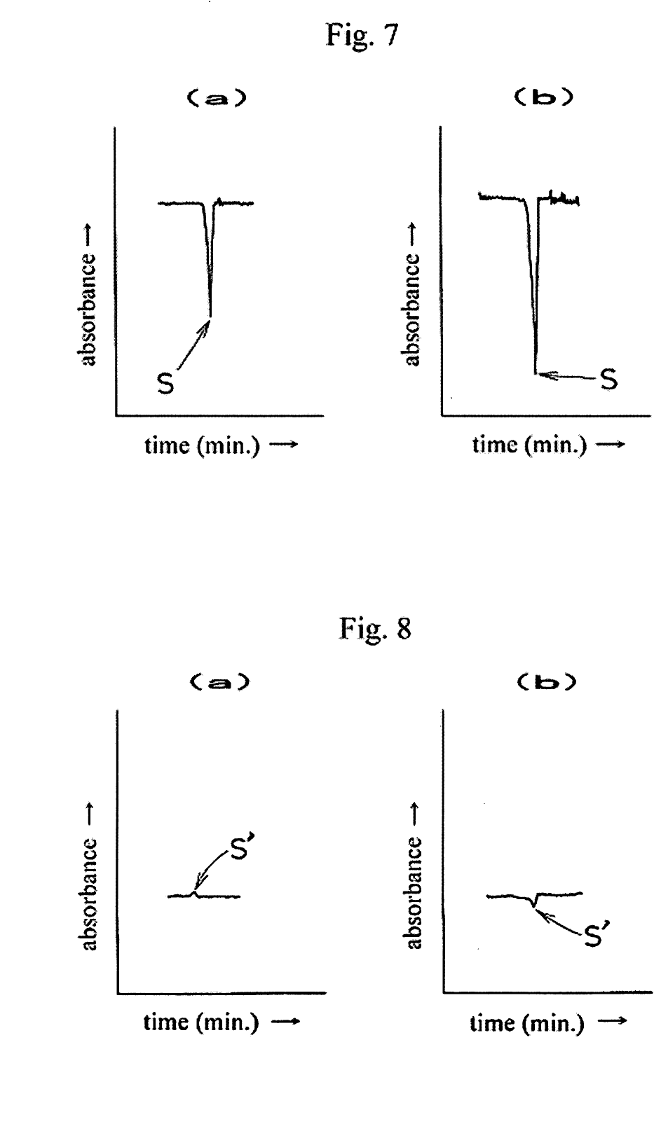

The sample detection was conducted under a ultraviolet light range of the wavelength of 254 nm. Consequently, as shown in FIG. 7(a), a clear peak (S) for the cyclohexanol was obtained in the Example 2 while as shown in FIG. 8(a), only a small peak (S′) for the cyclohexanol was obtained in the Comparative Example 2.

The sample detection was conducted under a visible light range of the wavelength of 400 nm. Consequently, as shown in FIG. 7(b), a clear peak (S) for the cyclohexanol was obtained in the Example 2 while as shown in FIG. 8(b), only a small peak (S′) for the cyclohexanol was obtained in the Comparative Example 2.

### EXAMPLE 3

In the above mentioned chromatography system, an ODS-column (ID 0.32×150 nm) was used as the separation column, a mixture solution of water and methanol with the mixture rate of 1:1 was used as a mobile phase, and a cyclohexanol was used as a sample. The flow rate was set to to 2 μl/min. A fused silica tube with the intenal diameter of 150 μm in which silica gel with the spherical diameter of 3 μm was fixed sparsely was used as the cell (da). In such a way, sample detection was conducted. For comparison with this cell (da), the same fused silica tube but no silica gel was fixed therein was used to detect the components of the sample under the same condition (Comparative Example 3).

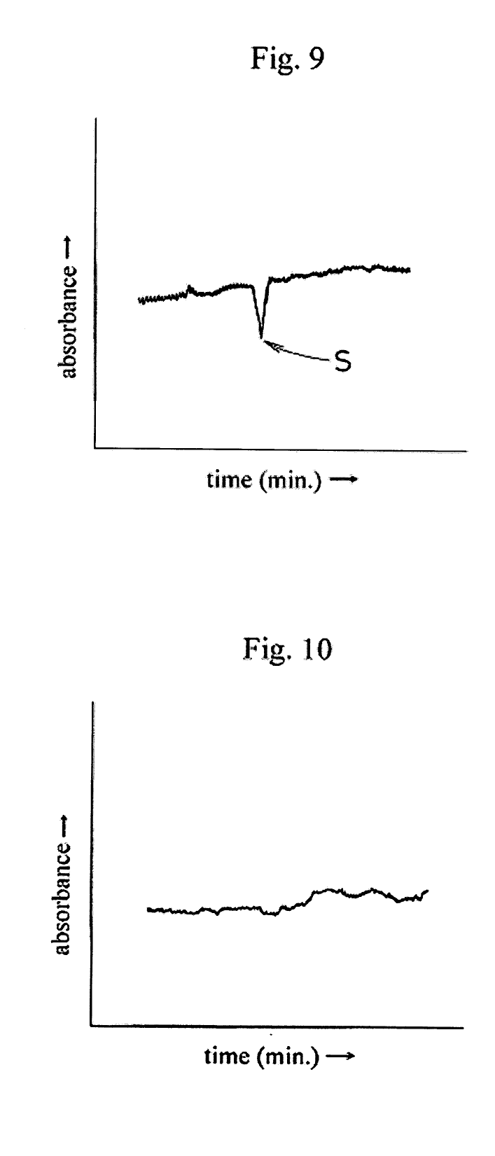

The sample detection was conducted under a visible light range of the wavelength of 700 nm. Consequently, as shown in FIG. 9, a clear peak (S) for the cyclohexanol was obtained in the Example 3 while as shown in FIG. 10, no peak for the cyclohexanol was obtained in the Comparative Example 3, such that the sample detection in the Comparative Example 3 was unsuccessful.

### EXAMPLE 4

In the above mentioned chromatography system, an ODS-column (ID 0.32×150 nm) was used as the separation column, a mixture solution of acetonitrile and water (9:1) containing 0.1 wt % of ethylene glycol solution was used as a mobile phase, and a 3% inositol aqueous solution and a 3% maltose aqueous solution were used as samples. The flow rate was set to 2 μl/min. A fused silica tube with the internal diameter of 150 μm in which silica gel with the spherical diameter of 3 μm was fixed sparsely was used as the cell (da). In such a way, the sample detection was conducted. For comparison with this cell (da), the same fused silica tube but no silica gel was fixed therein was used to detect the components of the sample under the same condition (Comparative Example 4).

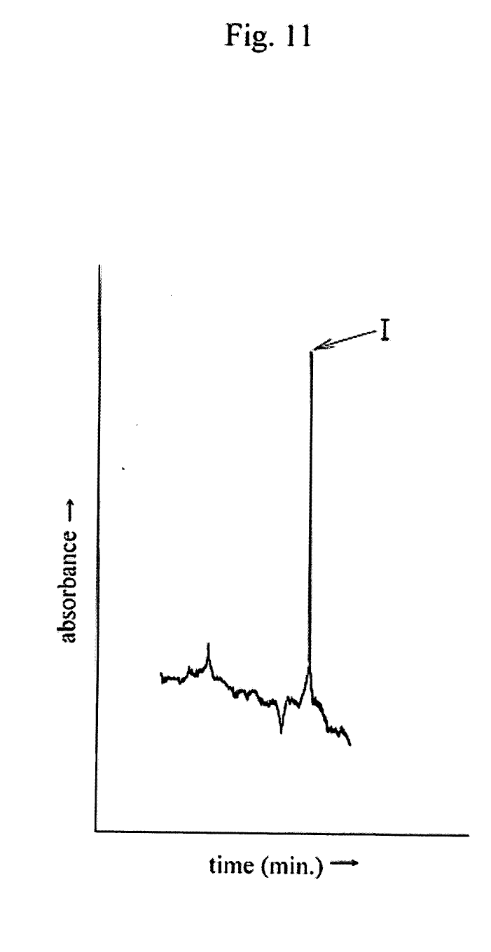

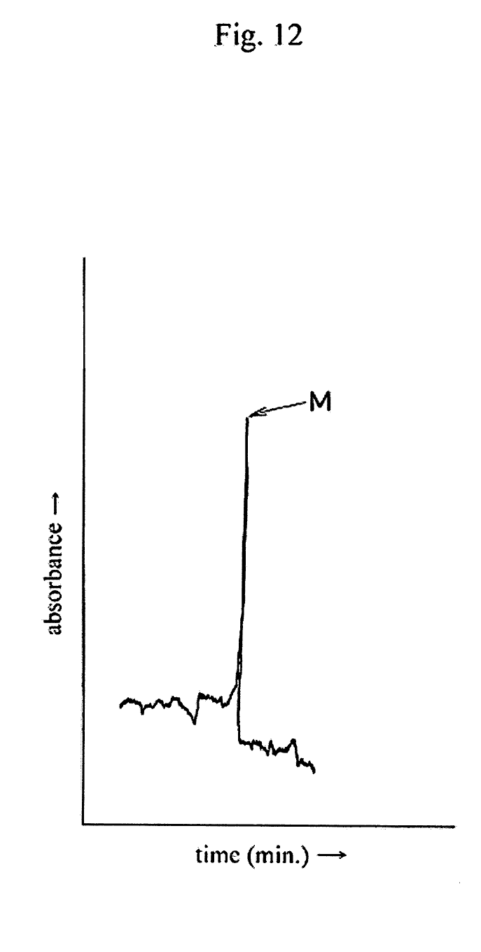

The sample detection was conducted under a visible light range of the wavelength of 400 nm. Consequently, as shown in FIGS. 11 and 12, a clear peak (I) for the inositol and a clear peak (M) for the maltose were obtained in the Example 4 while no peak for either inositol or maltose was obtained in the Comparative Example 4 (not shown in FIGS.), such that the sample detection in the Comparative Example 4 was unsuccessful.

1. A cell for sample detection in chromatography having a material fixed therein, wherein a translucency of the material is changed by an interaction between the material and samples.

2. A method for detecting samples in chromatography using the cell according to claim 1 comprising the steps of:
providing a light-emitting means and a light-receiving means;
providing the cell between the light-emitting means and the light-receiving means;
making samples flow through the cell; and
detecting components of the samples by utilizing a change of a translucency of the material fixed in the cell.

3. A sample detector for chromatography using the cell according to claim 1 comprising:
a light-emitting means and a light-receiving means,
wherein the cell is placed between the light-emitting means and the light-receiving means.
